(19) United States
(12) Patent Application Publication
(10) Pub. No.: US 2015/0267153 A1
(43) Pub. Date: Sep. 24, 2015

(54) PROCESS FOR PRODUCING LOW-IN-WATER TO WATER-FREE DETERGENT OR CLEANING AGENTS

(71) Applicant: Henkel AG & Co. KGaA, Duesseldorf (DE)

(72) Inventors: Konstantin Benda, Mettmann (DE); Thomas Eiting, Duesseldorf (DE); Nina Mussmann, Willich (DE); Volker Blank, Leverkusen (DE); Noelle Wrubbel, Duesseldorf (DE); Thorsten Bastigkeit, Wuppertal (DE); Oliver Kurth, Langenfeld (DE); Karl-Josef von den Driesch, Monheim (DE); Matthias Sunder, Duesseldorf (DE)

(21) Appl. No.: 14/729,221

(22) Filed: Jun. 3, 2015

Related U.S. Application Data
(63) Continuation of application No. PCT/EP2013/063772, filed on Jul. 1, 2013.

(30) Foreign Application Priority Data
Dec. 5, 2012 (DE) 10 2012 222 266.9

(51) Int. Cl. C11D 17/00; C11D 3/12; C11D 3/33; C11D 1/12

(52) U.S. Cl. CPC C11D 17/0004; C11D 1/12; C11D 3/1226; C11D 3/33

(57) ABSTRACT

The invention relates to a process for producing liquid, low-water to water-free detergents or cleaning agents, in particular a machine dishwashing detergent, which contain at least one sulfo polymer and at least one builder component, wherein, during the production, the at least one sulfo polymer is used in the form of an aqueous solution and the at least one builder component is used in solid form. The invention further relates to detergents and cleaning agents produced using said process and the use thereof.

### FIELD OF THE INVENTION

The present invention generally relates to a process for producing liquid, low-water to water-free detergents or cleaning agents, in particular an automatic dishwasher detergent, containing at least one sulfo polymer and at least one builder component, as well as the detergents and cleaning agents produced in this way and the use thereof.

### BACKGROUND OF THE INVENTION

Detergents and cleaning agents for hard surfaces as well as dishwasher detergents are available to consumers in a variety of product forms. In addition to the traditional solid agents, flowable and in particular liquid to gelatinous detergents and cleaning agents have become increasingly important in recent times. Consumers value in particular the rapid solubility and thus the rapid availability of the ingredients in the washing or cleaning bath associated with this, in particular also in short-term washing programs and at low temperatures.

The importance of concentrated compositions in which the water content in particular is reduced in comparison with traditional compositions is increasing. For the consumer, compositions having the lowest possible water content, for example, less than 20% by weight, are therefore particularly desirable.

Furthermore, consumers have become accustomed to convenient dosing of pre-apportioned automatic dishwasher detergents, and they have so far been using these products mainly in the form of tablets. It is customary to use cold water-soluble films in the form of bags for converting a liquid dishwasher detergent that offers the advantages mentioned above in comparison with solid compositions to a pre-apportioned product form. However, the development of formulas is limited thereby because only a limited amount of water can be incorporated into the product. Exceeding the tolerable amount of water leads to premature dissolving of the water-soluble film casing. To ensure good stability of these water-soluble containers in storage, water contents of less than 20% by weight are also desirable.

However, one problem with such formulations is that some raw materials are present either in the form of aqueous solutions, so that either the amount of these raw materials must be limited in order not to unintentionally increase the water content of the composition, or the raw materials must be used in solid form or dried, if chemically possible. The latter procedure often results in the problem of dissolving the required amount of solids in the small amount of available water.

Such a problem may occur even at water contents of 20% by weight or more. European Patent EP 1311654 B1 thus describes the production of aqueous liquid compositions having a water content of 20% to 50% by weight, wherein sodium salts are replaced by potassium salts for improved solubility of the ingredients, so that the molar ratio of the potassium ions to sodium ions in the total composition is between 0.55:1 and 20:1. In the process described there, sodium salts are first dissolved in water, preferably even the total amount of sodium salts, while the potassium salts and in particular potassium tripolyphosphate are added in another step.

Commercially available automatic dishwasher detergents today usually contain phosphates in the form of tripolyphosphates and so-called sulfo polymers. Tripolyphosphates are usually offered in a 50% to 60% by weight aqueous solution, sulfo polymers in solid form or as an approx. 30% to 40% by weight aqueous solution. If both raw materials are to be present in essential amounts in the product, then water contents of less than 20% by weight in the total composition cannot usually be achieved by using the raw materials in liquid form.

The applicant has now found that in the production of low-water compositions containing builders, in particular phosphate, the use of an aqueous builder component, in particular aqueous tripolyphosphate, in particular potassium tripolyphosphate or mixtures of potassium tripolyphosphate and sodium tripolyphosphate and addition of sulfo polymer in granular form leads to compositions in which phase separation occurs after several weeks of storage at room temperature. Such compositions therefore do not have adequate stability in storage. Another disadvantage with such compositions is that the dissolving time of the sulfo polymer in the TPP solution is very long and therefore also necessitates very long preparation times.

To overcome these problems, the applicant has conducted additional experiments and discovered that such phase separation can be prevented if, instead of aqueous tripolyphosphate and solid sulfo polymer, the reverse approach is selected and an aqueous sulfo polymer solution together with a solid tripolyphosphate (TPP) is used. Such a procedure also has the advantage that the dissolving time of solid TPP granules in an aqueous sulfo polymer solution is much shorter than in the reverse approach, which leads to an advantageous shortening of the preparation times.

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

Process for producing liquid low-water to water-free detergents or cleaning agents containing at least one sulfo polymer and at least one builder component, characterized in that in the production, the at least one sulfo polymer is used in the form of an aqueous solution and the at least one builder component is used in solid form, wherein the builder component in solid form is selected from tripolyphosphate, methyl glycine diacetic acid or a salt thereof (MGDA), glutamic acid diacetic acid or a salt thereof (GLDA) and combinations thereof.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

In a first aspect, the present invention relates to a process for producing liquid, low-water to water-free detergents or cleaning agents, which contain at least one sulfo polymer and at least one builder component, wherein the process is characterized in that, during production, the at least one sulfo polymer is used in the form of an aqueous solution and the at least one builder component is used in solid form.

The term “low-water,” as used herein, means that the composition characterized in this way contains less than 25% by weight water, preferably max. 20% by weight water or less, in particular preferably less than 15% by weight water. Compositions containing 1% to 20% by weight water, 1% to 15% by weight water, 5% to 15% by weight water or 10% to less than 20% by weight water in particular fall under this concept.

“Water-free,” as used herein, means that a composition contains less than 5% by weight, in particular less than 3% by weight, preferably <1% by weight water.

The water content, as defined herein, relates to the water content determined by means of Karl Fischer titration.

“Liquid” as used herein with respect to the detergent or cleaning agent produced includes all flowable compositions and also includes gels and pasty compositions in particular.

The term “solid form,” as used herein, relates to solids and includes forms such as powders and granules, for example.

“At least one,” as used herein, means 1 or more, for example, 1, 2, 3, 4, 5 or more.

The detergents and cleaning agents produced according to the invention are preferably a dishwashing detergent, in particular an automatic dishwasher detergent.

In another aspect, the invention relates to detergents or cleaning agents produced in this way that optionally can be present in a water-insoluble, water-soluble or water-dispersible packaging, for example, a film containing a single portion.

Another subject matter of the present invention is also an automatic dishwashing process in which a cleaning agent according to the invention is used.

In yet another aspect, the invention also relates to the use of the detergent or cleaning agent produced according to the invention as a dishwashing detergent, in particular an automatic dishwasher detergent.

The at least one builder component in solid form used in the process according to the invention is selected from tripolyphosphates (TPP), methyl glycine diacetic acid or a salt thereof (MGDA), glutamic acid diacetic acid or a salt thereof (GLDA) and combinations thereof. In preferred embodiments, the at least one builder component is tripolyphosphate.

Tripolyphosphates (or triphosphates) are condensation products of orthophosphoric acid (H₃PO₄) with the empirical formula P₃O₁₀⁵⁻ which are used in the process according to the invention in particular in the form of their salts, preferably the alkali metal or alkaline earth metal salts, more preferably in the form of their alkali metal salts. Tripolyphosphate salts are in general odorless, white, nonflammable hygroscopic solids that are readily soluble in water. According to the invention, the potassium salt of tripolyphosphate (K₅P₃O₁₀) or a mixture of the potassium salt of tripolyphosphate and the sodium salt of tripolyphosphate (Na₅P₃O₁₀) is used in particular because of its solubility. The weight ratio between potassium and sodium salt may be between 20:1 and 1:20, preferably between 20:1 and 1:1.

Methyl glycine N,N-diacetic acid and glutamic acid N,N-diacetic acid are used in the processes according to the invention in particular in the form of their salts, preferably the alkali metal or alkaline earth metal salts, more preferably in the form of their alkali metal salts. In particular the trisodium or tripotassium salt of MGDA and GLDA or a mixture of the sodium salt and the potassium salt is used according to the invention. Within the context of the present invention, the terms MGDA and/or GLDA is/are used as synonymous for the acid and also for the corresponding salts.

The amount by weight of the builder component in solid form in the total weight of the detergent or cleaning agent produced according to the invention is preferably 0.1 to 30% by weight, in particular 1 to 28% by weight, particularly preferably 5 to 25% by weight, and more preferably 10 to 20% by weight.

The amount by weight of the sulfo polymer in the total weight of the detergent or cleaning agent produced according to the invention is preferably 0.1 to 20% by weight, in particular 0.5 to 18% by weight, particularly preferably 1.0 to 15% by weight, in particular 4 to 14% by weight, particularly 6 to 12% by weight.

The aqueous solutions of the at least one sulfo polymer typically contain 20 to 70% by weight, in particular 30 to 50% by weight, preferably approx. 35 to 40% by weight sulfo polymer(s).

A polysulfonate copolymer, preferably a hydrophobically modified polysulfonate copolymer, is preferably used as the sulfo polymer.

The copolymers may contain two, three, four or more different monomer units.

Preferred polysulfonate copolymers contain at least one monomer from the group of unsaturated carboxylic acids in addition to monomer(s) containing sulfonic acid groups.

Unsaturated carboxylic acids of the formula R¹(R²)C═C(R³)COOH, in which R¹ to R³ independently of one another stand for —H, —CH₃, a linear or branched saturated alkyl radical with 2 to 12 carbon atoms, a linear or branched mono- or polyunsaturated alkenyl radical with 2 to 12 carbon atoms, —NH₂, —OH or —COOH-substituted alkyl or alkenyl radicals as defined above, or standing for —COOH or —COOR⁴, where R⁴ is a saturated or unsaturated linear or branched hydrocarbon radical with 1 to 12 carbon atoms are particularly preferably used as unsaturated carboxylic acid(s).

Particularly preferred unsaturated carboxylic acids include acrylic acid, methacrylic acid, ethacrylic acid, α-chloroacrylic acid, α-cyanoacrylic acid, crotonic acid, α-phenylacrylic acid, maleic acid, maleic anhydride, fumaric acid, itaconic acid, citraconic acid, methylene malonic acid, sorbic acid, cinnamic acid or mixtures thereof. The unsaturated dicarboxylic acids may of course also be used.

Preferred monomers containing sulfonic acid groups are those of the formula

R⁵(R⁶)C═C(R⁷)—X—SO₃H,

where R⁵ to R⁷ independently of one another stand for —H, —CH₃, a linear or branched saturated alkyl radical with 2 to 12 carbon atoms, a linear or branched mono- or polyunsaturated alkenyl radical with 2 to 12 carbon atoms, —NH₂, —OH or —COOH— substituted alkyl or alkenyl radicals or —COOH or —COOR⁴, where R⁴ is a saturated or unsaturated linear or branched hydrocarbon radical with 1 to 12 carbon atoms, and X stands for a spacer group, which is optionally present and is selected from —(CH₂)ₙ— where n=0 to 4, —COO—(CH₂)ₖ— where k=1 to 6, —C(O)—NH—C(CH₃)₂—, —C(O)—NH—C(CH₃)₂—CH₂— and —C(O)—NH—CH(CH₃)—CH₂—.

Among these monomers, the preferred ones are those of the formulas

H₂C═CH—X—SO₃H

H₂C═C(CH₃)—X—SO₃H

HO₃S—X—(R⁶)C═C(R⁷)—X—SO₃H,

where R⁶ and R⁷, independently of one another, are selected from —H, —CH₃, —CH₂CH₃, —CH₂CH₂CH₃ and —CH(CH₃)₂, and X stands for a spacer group, which is optionally present and is selected from —(CH₂)ₙ— where n=0 to 4, —COO—(CH₂)ₖ— where k=1 to 6, —C(O)—NH—C(CH₃)₂—, —C(O)—NH—C(CH₃)₂—CH₂— and —C(O)—NH—CH(CH₃)—CH₂—.

Particularly preferred monomers that contain sulfonic acid groups include 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 3-sulfopropyl methacrylate, sulfomethacrylamide, sulfomethyl methacrylamide as well as mixtures of the aforementioned acids or their water-soluble salts.

The sulfonic acid groups in the polymers may be present entirely or partially in neutralized form, i.e., in some or all of the sulfonic acid groups, the acidic hydrogen atom in the sulfonic acid group may be replaced by metal ions, preferably alkali metal ions and in particular sodium ions. The use of copolymers containing partially or fully neutralized sulfonic acid groups is preferred according to the invention.

The monomer distribution in the copolymers preferred for use according to the invention is preferably 5% to 95% by weight in copolymers that contain only monomers containing carboxylic acid groups and monomers containing sulfonic acid groups, particularly preferably the amount of the monomer containing sulfonic acid groups is 50% to 90% by weight and the amount of the monomer containing carboxylic acid groups is 10% to 50% by weight and the monomers here are preferably selected from those listed above.

The molecular weight of the sulfo copolymers preferred for use according to the invention may be varied to adjust the properties of the polymers to the desired intended purpose. Preferred cleaning agents are characterized in that the copolymers have molecular weights of 2000 to 200,000 gmol⁻¹, preferably 4000 to 25,000 gmol⁻¹ and in particular 5000 to 15,000 gmol⁻¹.

In another preferred embodiment, the copolymers also comprise at least one nonionic, preferably hydrophobic, monomer in addition to the monomer that contains carboxyl groups and the monomer that contains sulfonic acid groups. The clear rinsing performance of automatic dishwasher detergents according to the invention has been improved by using these hydrophobically modified polymers in particular.

Anionic copolymers comprising monomers that contain carboxylic acid groups, monomers that contain sulfonic acid groups and nonionic monomers, in particular hydrophobic monomers, are therefore preferred according to the invention.

Preferably monomers of the general formula R¹(R²)C═C(R³)—X—R⁴, in which R¹ to R³ independently of one another stand for —H, —CH₃ or —C₂H₅, X stands for a spacer group that is optionally present and is selected from —CH₂—, —C(O)O— and —C(O)—NH—, and R⁴ stands for a linear or branched saturated alkyl radical with 2 to 22 carbon atoms or for an unsaturated, preferably aromatic radical with 6 to 22 carbon atoms, are preferably used as the nonionic monomers.

Particularly preferred nonionic monomers include butene, isobutene, pentene, 3-methylbutene, 2-methylbutene, cyclopentene, hexene, 1-hexene, 2-methyl-1-pentene, 3-methyl-1-pentene, cyclohexene, methyl cyclopentene, cycloheptene, methyl cyclohexene, 2,4,4-trimethyl-1-pentene, 2,4,4-trimethyl-2-pentene, 2,3-dimethyl-1-hexene, 2,4-dimethyl-1-hexene, 2,5-dimethyl-1-hexene, 3,5-dimethyl-1-hexene, 4,4-dimethyl-1-hexane, ethyl cyclohexyne, 1-octene, α-olefins with 10 or more carbon atoms such as, for example, 1-decene, 1-dodecene, 1-hexadecene, 1-octadecene and C₂₂ α-olefin, 2-styrene, α-methylstyrene, 3-methylstyrene, 4-propylstyrene, 4-cyclohexylstyrene, 4-dodecylstyrene, 2-ethyl-4-benzylstyrene, 1-vinylnaphthalene, 2-vinylnaphthalene, acrylic acid methyl ester, acrylic acid ethyl ester, acrylic acid propyl ester, acrylic acid butyl ester, acrylic acid pentyl ester, acrylic acid hexyl ester, methacrylic acid methyl ester, N-(methyl)acrylamide, acrylic acid 2-ethylhexyl ester, methacrylic acid 2-ethylhexyl ester, N-(2-ethylhexyl)acrylamide, acrylic acid octyl ester, methacrylic acid octyl ester, N-(octyl)acrylamide, acrylic acid lauryl ester, methacrylic acid lauryl ester, N-(lauryl)acrylamide, acrylic acid stearyl ester, methacrylic acid stearyl ester, N-(stearyl)acrylamide, acrylic acid behenyl ester, methacrylic acid behenyl ester and N-(behenyl)acrylamide or mixtures thereof.

The monomer distribution of the hydrophobically modified copolymers preferred for use according to the invention preferably amounts to 5% to 80% by weight, with respect to the monomers that contain sulfonic acid groups, the hydrophobic monomer and the monomer that contains carboxylic acid groups; the amount of the monomer that contains sulfonic acid groups and of the hydrophobic monomer is particularly preferably 5% to 30% by weight each, and the amount of the monomer that contains carboxylic acid groups is 60% to 80% by weight; the monomers here are preferably selected from those listed above.

The detergents or cleaning agents produced with the process according to the invention may further contain at least one polyvalent alcohol. Such polyvalent alcohols can make it possible to incorporate other ingredients into a cleaning agent formulation when the amount of water is low, in particular when the amount of water is limited to 20% by weight.

The amount of polyvalent alcohol used in detergents or cleaning agents produced according to the invention is preferably at least about 20% by weight, in particular at least about 25% by weight, particularly preferably at least about 28% by weight, in particular about at least 30% by weight. Preferred quantity ranges here are 20% to 50% by weight, in particular 25% to 45% by weight, especially 28% to 40% by weight.

The polyvalent alcohol is preferably selected from glycerol, ethylene glycol, 1,2-propylene glycol, 1,3-propylene glycol, 2-methyl-1,3-propanediol and mixtures thereof.

In a preferred embodiment, a mixture of at least two polyvalent alcohols is used.

A polyvalent alcohol that is particularly preferred for use according to the invention is 1,2-propylene glycol. 1,2-Propylene glycol is preferably used in an amount of 1% to 40% by weight in agents according to the invention, in particular in an amount of 2% to 35% by weight, particularly preferably in an amount of 5% to 30% by weight, particularly 10% to 25% by weight.

Another polyvalent alcohol that is particularly preferred for use according to the invention is glycerol. Glycerol is preferably used in agents according to the invention in an amount of 1% to 40% by weight, in particular in an amount of 10% to 35% by weight, particularly preferably in an amount of 20% to 30% by weight.

In one embodiment that is particularly preferred, a mixture of glycerol and 1,2-propylene glycol is used.

The glycerol is preferably used here in an amount of 0.1% to 40% by weight, in particular in an amount of 15% to 35% by weight, particularly preferably in an amount of 20% to 30% by weight. The 1,2-propylene glycol is preferably used here in an amount of 1% to 20% by weight, in particular in an amount of 5% to 15% by weight, particularly preferably in an amount of 8% to 12% by weight, each based on the total weight of the cleaning agent, wherein the total amount of glycerol and 1,2-propylene glycol is preferably at least 20% by weight, in particular at least 25% by weight, especially at least 30% by weight, particularly preferably 25% to 45% by weight, in particular 30% to 42% by weight, especially 35% to 40% by weight. The weight ratios of glycerol:1,2-propylene glycol may be in the range of 1:1, preferably in the range of 1:1 to 3:1.

In various embodiments of the invention, the process comprises the following steps:
(1) providing the aqueous solution of at least one sulfo polymer, in particular together with at least one organic solvent;
(2) adding the at least one builder component in solid form, and
(3) stirring the mixture until the at least one builder component has dissolved.

The organic solvent is preferably the polyvalent alcohols described above, selected in particular selected from glycerol, ethylene glycol, 1,2-propylene glycol, 1,3-propylene glycol, 2-methyl-1,3-propanediol and mixtures thereof. Step (1) may begin either with the solvent to which the aqueous solution of the at least one sulfo polymer is added or, conversely, it may start with the solution of the sulfo polymer and the organic solvent is added. The at least one sulfo polymer and/or its aqueous solution is/are preferably as defined above.

The at least one builder component in solid form is preferably added in the form of a powder or granules. In various embodiments, this builder component is a salt as defined above, in particular a tripolyphosphate salt as defined above.

If mixtures of potassium and sodium salts of tripolyphosphate are used in the process, it is preferable for the sodium salt to be added before adding the potassium salt because the former has an inferior solubility.

As an additional ingredient, the detergents or cleaning agents may contain one or more builder substance(s) (builder/cobuilder) in addition to the builders listed as the builder component in solid form. The amount by weight of these additional builder substances in the total weight of the agents produced according to the invention is preferably 0.1% to 10% by weight and in particular 2% to 7% by weight. These builder substances which are different from the at least one builder component in solid form include in particular carbonates, citrates, phosphonates, EDDS (ethylenediamine-N,N′-disuccinic acid) or the salts thereof, organic cobuilders and silicates.

For example, it is possible to use carbonate(s) and/or bicarbonate(s), preferably alkali carbonate(s), particularly preferably sodium carbonate.

Organic cobuilders include in particular polycarboxylates/polycarboxylic acids, polymer carboxylates, aspartic acid, polyacetals, dextrins and organic cobuilders. These classes of substances are described below.

Organic builder substances that are usable and are different from the at least one builder component in solid form include, for example, the polycarboxylic acids that may be used in the form of the free acid and/or its sodium salts, wherein polycarboxylic acids are understood to be carboxylic acids having more than one acid function. These include, for example, citric acid, adipic acid, succinic acid, glutaric acid, malic acid, tartaric acid, maleic acid, fumaric acid, sugar acids, aminocarboxylic acids, nitrilotriacetic acid (NTA), as long as such use is not objectionable for ecological reasons, as well as mixtures thereof. The free acids typically also have the property of an acidification component in addition to their builder effect and thus also serve to adjust a lower and milder pH value of the cleaning agents. In particular citric acid, succinic acid, glutaric acid, adipic acid, gluconic acid and any mixtures thereof may be mentioned here.

Particularly preferred detergents or cleaning agents contain citrate, for example, sodium citrate, as one of their essential builder substances, which are different from the at least one builder component in solid form. Cleaning agents containing 1% to 10% by weight, preferably 2% to 5% by weight citrate are preferred according to the invention. The citrate is present in these embodiments in addition to the at least one solid builder component which is selected as described above from TPP, MGDA and GLDA. Citrates are preferably used in the processes according to the invention in the form of their salts, preferably the alkali metal or alkaline earth metal salts, more preferably in the form of their alkali metal salts. According to the invention, the trisodium or tripotassium salt of citric acid or a mixture of the sodium and potassium salt is used in particular.

In addition, polymer carboxylates are also suitable as builder substances that are different from the at least one builder component in solid form. These include, for example, the alkali metal salts of polyacrylic acid or of polymethacrylic acid, for example, those with a relative molecular weight of 500 to 70,000 g/mol.

Suitable polymers include in particular polyacrylates which preferably have a molecular weight of 2000 to 20,000 g/mol. Because of their superior solubility, the short-chain polyacrylates having molecular weights of 2000 to 10,000 g/mol and particularly preferably of 3000 to 5000 g/mol, may be preferred from this group.

The detergents or cleaning agents may in particular contain phosphonates as the additional builder substance that is different from the at least builder component in solid form. A hydroxyalkane phosphonate and/or an aminoalkane phosphonate is preferably used as the phosphonate compound. Of the hydroxyalkane phosphonates, 1-hydroxyethane-1,1-diphosphonate (HEDP) is particularly important. Ethylenediamine tetramethylene phosphonate (EDTMP), diethylenetriamine pentamethylene phosphonate (DTPMP) and their higher homologs are preferably considered as aminoalkane phosphonates. Phosphonates are preferably contained in the agents in amounts of 0.1% to 10% by weight, in particular in amounts of 0.5% to 8% by weight, each based on the total weight of the detergent or cleaning agent.

The detergents or cleaning agents may additionally contain, as the builder substance that is different from the at least one builder component in solid form, crystalline lamellar silicates of the general formula NaMSiₓO₂ₓ₊₁·yH₂O, where M denotes sodium or hydrogen, x is a number from 1.9 to 22, preferably from 1.9 to 4, especially preferred values for x are 2, 3 or 4, and y stands for a number from 0 to 33, preferably from 0 to 20. Amorphous sodium silicates with a modulus of Na₂O:SiO₂ of 1:2 to 1:3.3, preferably of 1:2 to 1:2.8, and in particular of 1:2 to 1:2.6, which are preferably delayed in dissolving and have secondary washing properties can also be used.

In preferred detergents or cleaning agents, the silicate content, based on the total weight of the cleaning agent, is limited to amounts below 10% by weight, preferably below 5% by weight and in particular below 2% by weight. Particularly preferred detergents or cleaning agents are free of silicate.

The additional builders that are added in addition to the at least one builder component in solid form are also preferably used in solid form or at least predominantly in solid form. Aqueous solutions are used only within the context that the desired low-water content of the agents is not exceeded. However, it is essential for the invention that the listed builder substances to be used as at least one builder component in solid form are selected from tripolyphosphate, MGDA, GLDA and mixtures thereof are not introduced into the process in liquid form.

In addition to the aforementioned builder substances, the detergents or cleaning agents may contain alkali metal hydroxides. These alkali carriers are preferably used in the cleaning agents only in small amounts, preferably in amounts below 10% by weight, preferably below 6% by weight, preferably below 5% by weight, particularly preferably between 0.1% and 5% by weight and in particular between 0.5% and 5% by weight, each based on the total weight of the cleaning agent. Alternative cleaning agents according to the invention are free of alkali metal hydroxides.

The additional builder substances listed above which are not included among the builder component in solid form, i.e., which are not TPP, MGDA or GLDA, may be introduced into the process either in solid form or in liquid form. It is preferable also for these additional builder substances, which are different from the at least one builder component in solid form, to be introduced primarily in solid form. In a particularly preferred embodiment of the invention, all the builder substances/builder substances that are used are used in solid form.

In one embodiment of the invention, the at least one builder component in solid form is tripolyphosphate, and the builder substance(s) which is/are different from the at least one builder component is/are citrate and/or phosphonate.

The addition of the builder substances which are different from the at least one builder component in solid form, in particular addition of citrate and/or phosphonate, may take place before step (2) or before step (3). In one embodiment, the process comprises the addition of citrate before step (2) or step (3). Alternatively, the builder substances, which are different from the at least one builder component in solid form, may also be added in step (3) after stirring. In one embodiment, for example, phosphonate is added in step (3) after stirring.

After stirring the mixture in step (3), then one or more additional ingredients may be added to the detergent or cleaning agent. These may be selected, for example, without restriction, from: nonionic surfactants, for example, hydroxy mixed ethers, and pH adjusting agents. The ingredients may be added, for example, in the order nonionic surfactant(s), pH adjusting agent. Since an exothermic neutralization reaction occurs on addition of the pH adjusting agents, the reaction mixture is preferably cooled in the process. In general it is preferably to have continuous stirring of the mixture during the addition of ingredients.

The detergents or cleaning agents produced according to the invention preferably also contain at least one nonionic surfactant. All the nonionic surfactants familiar to those skilled in the art may be used as the nonionic surfactants. Low-foaming nonionic surfactants are preferably used, in particular alkoxylated, especially ethoxylated low-foaming nonionic surfactants. The automatic dishwasher detergents particularly preferably contain nonionic surfactants from the group of alkoxylated alcohols.

Nonionic surfactants having a melting point above room temperature are preferred in particular. Nonionic surfactant(s) having a melting point above 20° C., preferably above 25° C., particularly preferably between 25 and 60° C. and in particular between 26.6 and 43.3° C. is/are particularly preferred.

Surfactants that are preferred for use come from the groups of alkoxylated nonionic surfactants, in particular ethoxylated primary alcohols and mixtures of these surfactants with structurally more complex surfactants, such as polyoxypropylene/polyoxyethylene/polyoxypropylene ((PO/EO/PO) surfactants). Such (PO/EO/PO) nonionic surfactants are also characterized by good foam control.

Low-foaming nonionic surfactants which have alternating ethylene oxide and alkylene oxide units are especially preferred nonionic surfactants in the context of the present invention. Of these, surfactants with EO-AO-EO-AO blocks are preferred, where one to ten EO and/or AO groups are bound to one another in each case before a block from the other groups follows. Nonionic surfactants of the following general formula are preferred:

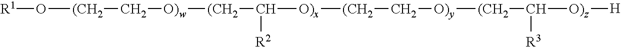

where R¹ stands for a linear or branched, saturated or mono- or polyunsaturated C₆-C₂₄ alkyl radical or alkenyl radical; each R² and/or R³ group, independently of one another, is selected from —CH₃, —CH₂CH₃, —CH₂CH₂—CH₃, CH(CH₃)₂, and indices w, x, y, z, independently of one another, stand for integers from 1 to 6.

Nonionic surfactants having a C₉-C₁₅ alkyl radical with 1 to 4 ethylene oxide units, followed by 1 to 4 propylene oxide units, followed by 1 to 4 ethylene oxide units, followed by 1 to 4 propylene oxide units are thus preferred in particular.

Preferred nonionic surfactants here are those of the general formula R¹—CH(OH)CH₂O-(AO)_{w}-(A′O)ₓ-(A″O)_{y}-(A′″O)_{z}—R², in which
R¹ stands for a linear or branched, saturated or mono- or polyunsaturated C₆₋₂₄ alkyl radical or alkenyl radical,
R² stands for H or a linear or branched hydrocarbon radical with 2 to 26 carbon atoms;
A, A′, A″ and A′″ independently of one another stand for a radical from the group of —CH₂CH₂, —CH₂CH₂—CH₂, —CH₂—CH(CH₃), —CH₂—CH₂—CH₂—CH₂, —CH₂—CH(CH₃)—CH₂—, —CH₂—CH(CH₂—CH₃),
w, x, y and z stand for values between 0.5 and 120, where x, y and/or z may also be 0.

Due to the addition of the aforementioned nonionic surfactants of the general formula R¹—CH(OH)CH₂O-(AO)_{w}-(A′O)ₓ-(A″O)_{y}-(A′″O)_{z}—R², hereinafter also referred to as “hydroxy mixed ethers,” the cleaning performance of the preparations produced according to the invention can be improved substantially, namely both in comparison with surfactant-free systems as well as in comparison with systems containing alternative nonionic surfactants, for example, from the group of polyalkoxylated fatty alcohols.

In particular, those end-group-capped poly(oxyalkylated) nonionic surfactants, which also have a linear or branched, saturated or unsaturated aliphatic or aromatic hydrocarbon radical R² with 1 to 30 carbon atoms, where x stands for values between 1 and 90, preferably for values between 30 and 80, and in particular for values between 30 and 60, in addition to a radical R¹ which stands for linear or branched, saturated or unsaturated aliphatic or aromatic hydrocarbon radicals with 2 to 30 carbon atoms, preferably with 4 to 22 carbon atoms according to the formula R¹O[CH₂CH₂O]ₓCH₂CH(OH)R² are preferred.

Especially preferred are surfactants of the formula R¹O[CH₂CH(CH₃)O]ₓ[CH₂CH₂O]_{y}CH₂CH(OH)R², in which R¹ stands for a linear or branched aliphatic hydrocarbon radical with 4 to 18 carbon atoms or mixtures thereof, R² stands for a linear or branched hydrocarbon radical with 2 to 26 carbon atoms or mixtures thereof, and x stands for values between 0.5 and 1.5 as well as y standing for a value of at least 15. The group of these nonionic surfactants includes, for example, the C₂₋₂₆ fatty alcohol (PO)₁-(EO)₁₅₋₄₀-2-hydroxyalkyl ethers, in particular also the C₈₋₁₀ fatty alcohol (PO)₁-(EO)₂₂-2-hydroxydecyl ethers.

In addition, end-group-capped poly(oxyalkylated) nonionic surfactants of the formula R¹O[CH₂CH₂O]ₓ[CH₂CH(R³)O]_{y}CH₂CH(OH)R², in which R¹ and R², independently of one another, stand for a linear or branched, saturated or mono- or polyunsaturated hydrocarbon radical with 2 to 26 carbon atoms, R³ is selected from —CH₃, —CH₂CH₃, —CH₂CH₂—CH₃, —CH(CH₃)₂, but preferably stands for —CH₃, and x and y, independently of one another, stand for values between 1 and 32, are particularly preferred, wherein nonionic surfactants with R³=—CH₃ and values for x of 15 to 32 and y of 0.5 and 1.5 are most especially preferred.

Additional nonionic surfactants that may preferably be used include the end-group-capped poly(oxyalkylated) nonionic surfactants of the formula R¹O[CH₂CH(R³)O]ₓ[CH₂]ₖCH(OH)[CH₂]ⱼOR², where R¹ and R² stand for linear or branched, saturated or unsaturated aliphatic or aromatic hydrocarbon radicals with 1 to 30 carbon atoms, R³ stands for H or a methyl, ethyl, n-propyl, isopropyl, n-butyl, 2-butyl or 2-methyl-2-butyl radical, x stands for values between 1 and 30, k and j stand for values between 1 and 12, preferably between 1 and 5. If the value x≧2, then each R³ in the above formula R¹O[CH₂CH(R³)O]ₓ[CH₂]ₖCH(OH)[CH₂]ⱼOR² may be different. R¹ and R² are preferably linear or branched, saturated or unsaturated aliphatic or aromatic hydrocarbon radicals with 6 to 22 carbon atoms, where radicals with 8 to 18 carbon atoms are especially preferred. H, —CH₃ or —CH₂CH₃ are especially preferred for the R³ radical. Especially preferred values for x are in the range of 1 to 20, in particular 6 to 15.

As described above, each R³ in the above formula may be different if x≧2. The alkylene oxide unit in the brackets can be varied in this way. For example, if x stands for 3, then the R³ radical can be selected to form ethylene oxide units (R³=H) or propylene oxide units (R³=CH₃) which may be linked together in any sequence, for example, (EO)(PO)(EO), (EO)(EO)(PO), (EO)(EO)(EO), (PO)(EO)(PO), (PO)(PO)(EO) and (PO)(PO)(PO). The value 3 for x has been selected here as an example and may easily be larger, wherein the range of variation increases with an increase in x values and includes, for example, a large number of (EO) groups combined with a small number of (PO) groups or vice versa.

Especially preferred end-group-capped poly(oxyalkylated) alcohols of the formulas given above have values of k=1 and j=1, so that the above formula is simplified to R¹O[CH₂CH(R³)O]ₓCH₂CH(OH)CH₂OR². In the latter formula, R¹, R² and R³ are as defined above and x stands for numbers from 1 to 30, preferably from 1 to 20, and in particular from 6 to 18. Surfactants in which the R¹ and R² radicals have 9 to 14 carbon atoms, R³ stands for H, and x assumes values of 6 to 15 are especially preferred.

Finally, the nonionic surfactants of the general formula R¹—CH(OH)CH₂O—(AO)_{w}—R² in which the following hold have proven to be especially effective:
R¹ stands for a linear or branched, saturated or mono- or polyunsaturated C₆₋₂₄ alkyl radical or alkenyl radical;
R² stands for a linear or branched hydrocarbon radical with 2 to 26 carbon atoms;
A stands for a radical from the group CH₂CH₂, CH₂CH₂CH₂, CH₂CH(CH₃), preferably for CH₂CH₂, and w stands for values between 1 and 120, preferably 10 to 80, in particular 20 to 40,
   have proven to be especially effective.

The group of these nonionic surfactants includes, for example, the C₄₋₂₂ fatty alcohol (EO)₁₀₋₈₀-2-hydroxyalkyl ethers, in particular also the C₈₋₁₂ fatty alcohol (EO)₂₂-2-hydroxydecyl ethers and the C₄₋₂₂ fatty alcohol (EO)₄₀₋₈₀-2-hydroxyalkyl ethers.

In various embodiments of the invention, instead of the end-group-capped hydroxy mixed ethers defined above, the corresponding non-end-group-capped hydroxy mixed ethers may also be used. These may conform to the above formulas in which, however, R² is hydrogen and R¹, R³, A, A′, A″, A′″, w, x, y and z are the same as defined above.

Preferred liquid cleaning agents produced according to the invention are characterized in that the cleaning agent contains at least one nonionic surfactant, preferably a nonionic surfactant from the group of hydroxy mixed ethers, where the amount by weight of the nonionic surfactant of the total weight of the cleaning agent is preferably 0.1% to 10% by weight, preferably 0.5% to 8.0% by weight, and in particular 1.0% to 4.0% by weight.

In general, the pH value of the detergent or cleaning agent can be adjusted by means of the usual pH regulators, wherein the pH value is selected depending on the desired intended purpose. In various embodiments, the pH value is in a range of 5.5 to 10.5, preferably 5.5 to 9.5, more preferably 7 to 9, in particular greater than 7, especially in the range of 7.5 to 8.5. Acids and/or alkalis, preferably alkalis are used as pH adjusting agents. Suitable acids include in particular organic acids such as acetic acid, citric acid, glycolic acid, lactic acid, succinic acid, adipic acid, malic acid, tartaric acid and gluconic acid or amidosulfonic acid. In addition, however, the mineral acids hydrochloric acid, sulfuric acid and nitric acid and/or mixtures thereof may also be used. Suitable bases come from the group of alkali and alkaline earth metal hydroxides and carbonates, in particular the alkali metal hydroxides, of which potassium hydroxide and in particular sodium hydroxide are preferred. However, volatile alkali, for example, in the form of ammonia and/or alkanolamines, which may contain up to 9 carbon atoms in the molecule, are particularly preferred. The alkanolamine here is preferably selected from the group consisting of mono-, di-, triethanol and propanolamine and mixtures thereof. The alkanolamine is preferably contained in the agents produced according to the invention in an amount of 0.5% to 10% by weight, in particular in an amount of 1% to 6% by weight.

To adjust and/or stabilize the pH value, the agent produced according to the invention may contain one or more buffer substances (INCI buffering agents), usually in amounts of 0.001% to 5% by weight. Buffer substances which are complexing agents or even chelating agents (chelators, INCI chelating agents) at the same time are preferred. Especially preferred buffer substances include citric acid and/or citrates, in particular sodium and potassium citrates, for example, trisodium citrate.2H₂O and tripotassium citrate.H₂O.

The agents produced according to the invention preferably contain at least one additional ingredient, preferably selected from the group consisting of anionic, cationic and amphoteric surfactants, bleaching agents, bleach activators, bleach catalysts, enzymes, thickeners, sequestering agents, electrolytes, corrosion inhibitors, in particular silver protectants, glass corrosion inhibitors, foam inhibitors, coloring agents, fragrances, bitter substances and antimicrobial active ingredients.

Preferred anionic surfactants include fatty alcohol sulfates, fatty alcohol ether sulfates, dialkyl ether sulfates, monoglyceride sulfates, alkylbenzene sulfonates, olefin sulfonates, alkane sulfonates, ether sulfonates, n-alkyl ether sulfonates, ester sulfonates and lignin sulfonates.

The anionic surfactants are preferably used as sodium salts but may also be present as other alkali or alkaline earth metal salts, for example, potassium or magnesium salts, as well as in the form of ammonium or mono-, di-, tri- and/or tetraalkylammonium salts, also in the form of their corresponding acid, e.g., dodecylbenzene sulfonic acid, in the case of sulfonates.

Suitable amphoteric surfactants include, for example, betaines of the formula (Rⁱⁱⁱ)(R^{iv})(R^{v})N⁺CH₂COO⁻, in which Rⁱⁱⁱ denotes an alkyl radical with 8 to 25 carbon atoms, preferably 10 to 21 carbon atoms, optionally interrupted by heteroatoms or heteroatom groups, and R^{iv} and R^{v} denote similar or different alkyl radicals with 1 to 3 carbon atoms, in particular C₁₀-C₁₈ alkyldimethylcarboxymethylbetaine and C₁₁-C₁₇ alkylamido-propyldimethylcarboxymethylbetaine.

Suitable cationic surfactants include, among others, the quaternary ammonium compounds of formula (R^{vi})(R^{vii})(R^{viii})(R^{ix})N⁺X⁻, in which R^{vi} to R^{ix} stand for four similar or different alkyl radicals, in particular two long-chain alkyl radicals and two short-chain alkyl radicals, and X⁻ stands for an anion, in particular a halide ion, for example, didecyldimethylammonium chloride, alkylbenzyldidecylammonium chloride and mixtures thereof. Other suitable cationic surfactants include the quaternary surface-active compounds, in particular those with a sulfonium, phosphonium, iodonium or arsonium group which are also known as antimicrobial active ingredients. By using quaternary surface-active compounds with an antimicrobial effect, the agent may be embodied with an antimicrobial effect, or its antimicrobial effect, which is optionally already present based on other ingredients, may be improved.

The enzymes include in particular proteases, amylases, lipases, hemicellulases, cellulases, perhydrolases or oxidoreductases as well as preferably mixtures thereof. These enzymes are in principle of natural origin. Starting from the natural molecules, improved variants are available for use in cleaning agents and are preferred for use accordingly. Cleaning agents according to the invention preferably contain enzymes in total amounts of 1×10⁻⁶ to 5% by weight, based on active protein. The protein concentration can be determined by using known processes, for example, the BCA method or the biuret method.

A protein and/or enzyme may be protected, particularly during storage, against damage such as, for example, inactivation, denaturing or decomposition due to physical influences, oxidation or proteolytic cleavage. In the case of microbial production of the proteins and/or enzymes, inhibition of proteolysis is particularly preferred, in particular if the agents also contain proteases. Cleaning agents may contain stabilizers for this purpose; supplying such agents constitutes a preferred embodiment of the present invention.

The glass corrosion inhibitors that are used are preferably zinc salts, in particular zinc acetate. Glass corrosion inhibitors are preferably present in the agents produced according to the invention in an amount of 0.05% to 5% by weight, in particular in an amount of 0.1% to 2% by weight.

The aforementioned additional ingredients are preferably added after the neutralization reaction, i.e., the adjustment of the pH value and optionally a stirring step performed with the adjustment of pH or afterwards. In particular after the pH adjustment, one or more of the substances selected from the group consisting of cationic surfactants, amphoteric surfactants, zinc acetate, coloring agents, fragrances, bitter substances, enzymes and preservatives may be added in any order.

The required stirring steps are carried out in the processes according to the invention, for example, after adding the builder substance, such as the tripolyphosphate, for example, to dissolve same, and in adjusting the pH value and the neutralization required to do so, preferably in a mixer with a stirrer that travels along the wall, in particular an anchor stirrer or a spiral stirrer. The stirrer preferably has a geometry that ensures complete mixing of the entire reaction mixture. In various embodiments, the stirrer therefore has a stirrer geometry d/D of at least 0.9, preferably greater than 0.9 to 0.99, where d is the diameter of the stirrer and D is the diameter of the mixer.

The invention also relates to the detergents or cleaning agents produced by using the process according to the invention. These are characterized on the one hand by their ingredients and on the other hand in that they are stable in storage and there is no phase separation even after a longer period of time.

In various embodiments, the detergent or cleaning agent immediately after production has a viscosity above 2000 mPas (Brookfield viscometer DV-II+Pro, spindle 25, 30 rpm, 20° C.), in particular between 2000 and 10,000 mPas. After storage the viscosity may be higher, for example, higher than 10,000 mPas, such as in the range of 10,000-50,000 mPas, for example, preferably about 35,000 mPas (Brookfield viscometer DV-II+Pro, spindle 25, 5 rpm, 20° C.).

The detergent or cleaning agent may be in a water-insoluble, water-soluble or water-dispersible packaging. The invention therefore also relates to kits containing the detergent or cleaning agent together with such packaging. The detergent or cleaning agent may be finished in such a way that single portions are packaged separately.

The cleaning agent according to the invention is preferably contained in a water-soluble packaging. The water-soluble packaging allows portioning of the cleaning agent. The amount of cleaning agent in the portion package is preferably 5 to 50 g, particularly preferably 10 to 30 g, in particular 15 to 25 g.

The water-soluble casing is preferably formed from a water-soluble film material which is selected from the group consisting of polymers or polymer mixtures. The casing may be formed from one or two or more layers of the water-soluble film material. The water-soluble film material of the first layer and of the additional layers, if present, may be the same or different. Films that can be glued and/or sealed to form packagings, such as tubes or pods, after being filled with an agent, are preferred in particular.

It is preferable for the water-soluble casing to contain polyvinyl alcohol or a polyvinyl alcohol copolymer. Water-soluble casings containing polyvinyl alcohol or a polyvinyl alcohol copolymer have a good stability with a sufficiently high water solubility, in particular a cold water solubility.

Suitable water-soluble films for producing the water-soluble casing are preferably based on a polyvinyl alcohol or a polyvinyl alcohol copolymer whose molecular weight is in the range of 10,000 to 1,000,000 gmol⁻¹, preferably of 20,000 to 500,000 gmol⁻¹, particularly preferably of 30,000 to 100,000 gmol⁻¹ and in particular of 40,000 to 80,000 gmol⁻¹.

Polyvinyl alcohol is usually produced by hydrolysis of polyvinyl acetate because the direct synthesis pathway is impossible. The situation is similar for polyvinyl alcohol copolymers that are produced from polyvinyl acetate copolymers accordingly. It is preferably if at least one layer of the water-soluble casing comprises a polyvinyl alcohol whose degree of hydrolysis constitutes 70 to 100 mol %, preferably 80 to 90 mol %, particularly preferably 81 to 89 mol %, and in particular 82 to 88 mol %.

A polymer selected from the group comprising (meth)acrylic acid-containing (co)polymers, polyacrylamides, oxazoline polymers, polystyrene sulfonates, polyurethanes, polyesters, polyethers, polylactic acid or mixtures of the aforementioned polymers can additionally be added to a polyvinyl alcohol-containing film material suitable for producing the water-soluble wrapping. A preferred additional polymer is polylactic acids.

Preferred polyvinyl alcohol copolymers comprise, in addition to vinyl alcohol, dicarboxylic acids as additional monomers. Suitable dicarboxylic acids include itaconic acid, malonic acid, succinic acid and mixtures thereof, but itaconic acid is preferred.

Polyvinyl alcohol copolymers, which are likewise preferred, comprise in addition to vinyl alcohol an ethylenically unsaturated carboxylic acid, the salt or ester thereof. Such polyvinyl alcohol copolymers particularly preferably contain, in addition to vinyl alcohol, acrylic acid, methacrylic acid, acrylic acid ester, methacrylic acid ester or mixtures thereof.

It may be preferable for the film material to contain additional additives. The film material may contain, for example, plasticizers such as dipropylene glycol, ethylene glycol, diethylene glycol, propylene glycol, glycerol, sorbitol, mannitol or mixtures thereof. Additional additives comprise, for example, release aids, fillers, crosslinking agents, surfactants, antioxidants, UV absorbers, antiblocking agents, antisticking agents or mixtures thereof.

Suitable water-soluble films for use in the water-soluble casings of the water-soluble packagings according to the invention are films distributed by the company MonoSol LLC, for example, under the designation M8630, C8400 or M8900. Other suitable films comprise films with the designation Solublon® PT, Solublon® GA, Solublon® KC or Solublon® KL from Aicello Chemical Europe GmbH or the films VF-HP from Kuraray.

### EXEMPLARY EMBODIMENTS

The cleaning agents V1 and E1 and E2 were prepared. The compositions are shown in the following table, where the quantity amounts are given in percent of active substance by weight.

| | | V1 | E1 | E2 |
|---|---|---|---|---|
| 1 | Potassium tripolyphosphate | 35 (60% | 21 | 21 |
| | | in H₂O) | | |
| 2 | Sulfo polymer | 8.5 | 22 (38% | 22.5 (38% in |
| | | | in H₂O) | H₂O) |
| 3 | Citrate | 4 | 4 | 4 |
| 4 | Glycerol | 27 | 27 | 27 |
| 5 | 1,2-Propylene glycol | 10 | 10 | 10 |
| 6 | Hydroxy mixed ether | 2 | 2 | 2 |
| 7 | Acrylic acid polymer, sodium | 1 | 1 | 1 |
| | salt (20% in H₂O) | | | |
| 8 | Ethanolamine | 3.5 | 3.5 | 3.5 |
| 9 | Phosphonate | 3.5 | 3.5 | 4 |
| 10 | Enzyme preparation (solid) | 4 | 4 | 4 |
| 11 | Perfume, coloring agent, | To 100 | To 100 | To 100 |
| | additives | | | |
| 12 | Optionally water | | | |
| | (to adjust the water content) | | | |
| | Water content (%) | 16.7 | 16.3 | 18.5 |

Composition V1, which is not according to the invention, was prepared by mixing the ingredients in the following order: 1/4/5 mixed and provided—2—3—stirring—9—6—8—stirring—7/10/12. After being stored for 4 weeks at room temperature, phase separation occurred with this composition.

Compositions E1/E2 which are according to the invention were prepared by mixing the ingredients in the following order: 2/4/5 mixed and provided—1—3—stirring—9—6—8—stirring—7/10/11/12. After being stored for more than 4 weeks at room temperature, no phase separation occurred with these compositions, in contrast with composition V1.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. Process for producing liquid low-water to water-free detergents or cleaning agents wherein at least one sulfo polymer and at least one builder component, are mixed together, wherein the at least one sulfo polymer is used in the form of an aqueous solution and the at least one builder component is used in solid form, wherein the builder component in solid form is selected from tripolyphosphate, methyl glycine diacetic acid or a salt thereof (MGDA), glutamic acid diacetic acid or a salt thereof (GLDA) and combinations thereof.

2. Process according to claim 1, wherein the detergent or cleaning agent has a water content of less than 20% by weight.

3. Process according to claim 2, wherein the detergent or cleaning agent also contains at least one polyvalent alcohol selected from the group consisting of glycerol, ethylene glycol, 1,2-propylene glycol, 1,3-propylene glycol, 2-methyl-1,3-propanediol and mixture thereof.

4. Process according to claim 1, comprising the following steps:
(1) providing the aqueous solution of at least one sulfo polymer;
(2) adding at least one builder component in solid form; and
(3) stirring the mixture until the at least one builder component in solid form has dissolved.

5. Process according to claim 4, wherein in step (2) the at least one builder component in solid form is a tripolyphosphate comprising potassium tripolyphosphate and sodium tripolyphosphate, and wherein the sodium tripolyphosphate is added before adding the potassium tripolyphosphate.

6. Process according to claim 4, wherein before step (2) or before step (3), at least one additional builder substance, which is different from the at least one builder component, is added.

7. Process according to claim 4, wherein after step (3), one or more of the substances selected from the group consisting of nonionic surfactants and pH adjusting agents are added in any order and the mixture is then stirred and, if pH adjusting agents are added, optionally cooled.

8. Process according to claim 7, wherein a mixer with a stirrer that travels along the wall, having a stirrer geometry d/D of at least 0.9 is used for stirring the mixture, where d is the diameter of the stirrer and D is the diameter of the mixer.
